(19) United States
(12) Patent Application Publication
(10) Pub. No.: US 2025/0369775 A1
(43) Pub. Date: Dec. 4, 2025

(54) DUST BOX ASSEMBLY, CLEANING DEVICE AND DETECTION METHOD FOR DUST BOX’S DUST FULLNESS

(71) Applicant: ROBOTIN (SHENZHEN) CO., LTD., Shenzhen (CN)

(72) Inventors: Zhouxiong LIN, Shenzhen (CN); Jun LONG, Shenzhen (CN); Yuhui LI, Shenzhen (CN)

(73) Assignee: ROBOTIN (SHENZHEN) CO., LTD., Shenzhen (CN)

(21) Appl. No.: 18/746,477

(22) Filed: Jun. 18, 2024

Related U.S. Application Data
(63) Continuation of application No. PCT/CN2024/097327, filed on Jun. 4, 2024.

(30) Foreign Application Priority Data
May 29, 2024 (CN) 202410679787.2

(51) Int. Cl. G01D 5/14; A47L 9/14; A47L 9/28; G01B 7/30

(52) U.S. Cl. CPC G01D 5/145; A47L 9/14; A47L 9/2805; G01B 7/30

(57) ABSTRACT

Disclosed are a dust box assembly, a cleaning device, and a detection method for a dust box's dust fullness, which relate to the technical field of cleaning machines. A dust box is applied to a cleaning device, the cleaning device includes a fan assembly and a dust box, the fan assembly communicates with the dust box via a dust inlet, and a flip cover flipped to open and close the dust inlet is provided in the dust box. The detection method includes: obtaining a target distance between the flip cover and the dust inlet by a processor, and storing the target distance in a memory by the processor; obtaining an operating distance between the flip cover and the dust inlet by a detection module; and comparing the target distance with the operating distance by the processor, and determining whether the dust box is full of dust by the processor.

### CROSS-REFERENCE TO RELATED APPLICATIONS

This application is a continuation application of International Application No. PCT/CN2024/097327, filed on Jun. 4, 2024, which claims priority to Chinese Patent Application No. 202410679787.2, filed on May 29, 2024. The disclosures of the above-mentioned application are incorporated herein by reference in its entirety.

### TECHNICAL FIELD

The present application relates to the technical field of cleaning machines, and in particular to a dust box assembly, a cleaning device, and a detection method for a dust box's dust fullness.

### BACKGROUND

The cleaning robot temporarily stores the garbage collected during the cleaning process in a dust box, and the dust box is provided with a dust inlet for sucking in the garbage. The cleaning robot is usually provided with a detection mechanism to determine whether the dust box is full of dust, so as to remind the user to clean the dust box. In the related art, it is usually adopted to detect whether the dust box is full of dust by means of detecting pressure in the dust box, setting the cleaning time, etc. However, these types of detection methods is easily affected by environmental factors, such as the impact of flowing air on air pressure, the mismatch between cleaning time and the amount of garbage in the working environment, etc., which often leads to misjudgment, thus reducing the detection accuracy of the dust box's dust fullness.

### SUMMARY

The main purpose of the present application is to propose a dust box assembly, a cleaning device, and a dust fullness detection method for a cleaning device, which determines whether the dust box is full of dust by judging the closing status of the flip cover of the dust inlet, thus improving the detection accuracy of the dust box's dust fullness.

To achieve the above purpose, the detection method for the dust box's dust fullness proposed in the present application is applied to a cleaning device, the cleaning device includes a fan assembly and a dust box, the fan assembly communicates with the dust box via a dust inlet, and a flip cover flipped to open and close the dust inlet is provided in the dust box; the detection method includes:
obtaining a target distance between the flip cover and the dust inlet by a processor, and storing the target distance in a memory by the processor;
obtaining an operating distance between the flip cover and the dust inlet by a detection module; and
comparing the target distance with the operating distance by the processor, and determining whether the dust box is full of dust by the processor.

In an embodiment, the comparing the target distance with the operating distance by the processor, and determining whether the dust box is full of dust by the processor includes:

in response to that the fan assembly is operating, the operating distance being less than the target distance, determining that the dust box is full of dust by the processor.

In an embodiment, within a range of the target distance, an angle between the flip cover and a side wall of the dust box where the dust inlet is provided is between 0° and 30°.

In an embodiment, the comparing the target distance with the operating distance by the processor, and determining whether the dust box is full of dust by the processor includes:

in response to that the fan assembly stops operating, the operating distance being greater than the target distance, determining that the dust box is full of dust by the processor.

In an embodiment, a value of the target distance is zero.

The present application further proposes a dust box assembly, the dust box assembly is applied to a cleaning device, the cleaning device further includes a processor and a memory, and the memory stores a control program executable on the processor; in response to that the processor executes the control program, the detection method as described above is implemented; the dust box assembly includes:
a box body provided with a dust inlet;
a flip cover flipably provided in the box body to open and close the dust inlet; and
a detection module electrically connected to the processor, the detection module is configured to obtain an operating distance between the flip cover and the dust inlet.

In an embodiment, the box body is provided with an air inlet side wall inclined relative to a horizontal plane, the air inlet side wall is provided with the dust inlet, and a rotating shaft of the flip cover is provided at the air inlet side wall and provided at an upper side of the dust inlet; in response to that the cleaning device stops operating, the flip cover is covered at the dust inlet.

In an embodiment, the box body further includes a top cover connected to an upper edge of the air inlet side wall, the detection module is provided adjacent to the dust inlet and/or provided at the top cover, and a detection head of the detection module is opposite to the flip cover in a rotation direction of the flip cover.

In an embodiment, the flip cover includes a cover plate and a to-be-detected part provided at both sides of the rotating shaft, the cover plate is provided in the box body to open and close the dust inlet; the detection head of the detection module is provided toward an extension direction of the rotating shaft and is opposite to the to-be-detected part in response to that the cover plate covers the dust inlet.

In an embodiment, the detection module includes a Hall sensor and a first magnetic member provided at the flip cover.

In an embodiment, the detection module includes a magnetic angle sensor and a second magnetic member provided at the flip cover.

In an embodiment, the detection module includes a photoelectric sensor.

The present application further proposes a cleaning device, including a dust box assembly, a processor, and a memory; the dust box assembly is configured as the dust box assembly as described above; the memory stores a control program executable on the processor, and in response to that the processor executes the control program, the detection method as described above is implemented.

The present application further proposes a non-transitory computer readable storage medium, a control program is stored on the computer readable storage medium, and in response to that the control program is executed by a processor, the detection method as described above is implemented.

The technical solution of the present application firstly tests the target distance of the distance between the flip cover and the dust inlet under various usage conditions in a state that the dust box is full of dust. For example, when the cleaning device is at the beginning of use or in use, whether the flip cover can open the dust inlet or maintain flipping to a reasonable position; or, when the cleaning device is in the state of not being used or just finishing use, whether the flip cover can cover the dust inlet or be covered to a reasonable position. The distance between the flip cover and the dust inlet under this judgment standard is the target distance. After determining the target distance, the cleaning device, in any condition, the detection module will detect the actual distance between the flip cover and the dust inlet. The actual distance is the operating distance between the flip cover and the dust inlet. Then, by comparing the operating distance and the target distance, if the operating distance is outside the range of the target distance, it is determined that the dust box is full and needs to be cleaned; if the operating distance is within the target distance, it is determined that the dust box is not full and can continue to be used. It can be understood that the standard for whether the dust box is full of dust is that the dust inlet can be used normally, and the relationship between the flip cover and the dust inlet can better reflect whether the dust inlet is in a normal use state, thereby achieving a relatively accurate determination of whether the dust box is full of dust.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below. Obviously, the accompanying drawings in the following description are only some embodiments of the present application, other accompanying drawings can be obtained based on the provided accompanying drawings without exerting creative efforts for those skilled in the art.

FIG. 1 is a structural schematic view that a dust box assembly is installed at an installation shell of a cleaning device provided by an embodiment of the present application.

FIG. 2 is an exploded schematic view of the dust box assembly and the installation shell in FIG. 1.

FIG. 3 is a cross-sectional view of the dust inlet of the dust box assembly being in a closed state in FIG. 1.

FIG. 4 is a cross-sectional view of the dust inlet of the dust box assembly being in an open state in FIG. 1.

FIG. 5 is a cross-sectional view of a dust inlet of a dust box assembly being in a closed state provided by another embodiment of the present application.

FIG. 6 is a cross-sectional view of a dust inlet of a dust box assembly being in an open state provided by another embodiment of the present application.

FIG. 7 is a cross-sectional view of a dust inlet of a dust box assembly being in a closed state provided by yet another embodiment of the present application.

FIG. 8 is a cross-sectional view of a dust inlet of a dust box assembly being in an open state provided by yet another embodiment of the present application.

FIG. 9 is a flow chart of a detection method for a dust box's dust fullness provided by an embodiment of the present application.

FIG. 10 is a flow chart of a detection method for a dust box's dust fullness provided by another embodiment of the present application.

FIG. 11 is a system control logic diagram of a cleaning device provided by an embodiment of the present application.

The realization of the purpose, functional features and advantages of the present application will be further described in conjunction with the embodiments and with reference to the accompanying drawings.

### DETAILED DESCRIPTION OF THE EMBODIMENTS

The technical solutions in the embodiments according to the present application will be clearly and completely described below in conjunction with the accompanying drawings in the embodiments according to the present application, and it is clear that the described embodiments are only a part of the embodiments according to the present application, and not all of the embodiments. Based on the embodiments in the present application, all other embodiments obtained by those skilled in the art without making creative labor fall within the scope of the present application.

It should be noted that if there are directional instructions (such as up, down, left, right, front, back or the like) involved in the embodiments of the present application, the directional indications are only used to explain the relative positional relationship, movement and so on between various components in a specific posture (as shown in the accompanying drawings). If the specific posture changes, the directional indication will also change accordingly.

In addition, if there are descriptions involving “first”, “second” or the like in the embodiments of the present application, the descriptions of “first”, “second” or the like are only for descriptive purposes and cannot be understood as indicating or implying the relative importance or implicitly indicating the quantity of the technical features indicated. Therefore, features defined as “first” and “second” may explicitly or implicitly include at least one of these features. In addition, the meaning of “and/or” appearing in the entire text includes three parallel solutions, taking “A and/or B” as an example, it includes solution A, or solution B, or a solution that satisfies both A and B at the same time. In addition, the technical solutions of various embodiments can be combined with each other, but it is based on that those skilled in the art can realize. When the combination of technical solutions is contradictory or cannot be realized, it should be considered that such combination of technical solutions does not exist and is not within the protection scope claimed by the present application.

In the prior art, when cleaning devices such as cleaning robots are cleaning environmental targets, the dust box inside them will continuously store the collected garbage and other debris. Generally speaking, the cleaning device sucks away the garbage by vacuum adsorption, and the dust box is provided with a dust inlet for the garbage to be sucked in. In order to facilitate the use of users, a dust fullness detection device is usually provided in the dust box to determine whether the dust box is full of dust, and then remind the user to clean the garbage in the dust box. Existing dust fullness detection technologies include: optical detection, pressure detection, and setting the duration. The optical detection places a photoelectric switch at the position where the dust box is filled with garbage the latest. Considering the uncertainty of the shape of the garbage, the uncertainty of the position where the garbage blocks the detection light, and the uncertainty of the light transmittance of the garbage, this optical detection method is prone to false detection, and the false detection rate will be very high. The pressure detection judges whether the dust box is full of dust by detecting the size of the negative pressure in the dust box. However, the loose degree of the garbage will greatly affect the negative pressure in the dust box. Moreover, under the same suction force, whether there is garbage in the dust box or whether the garbage is full has relatively little effect on the negative pressure. The requirements for detecting whether the dust box is full of dust in this way are relatively high. As for the setting the duration, by setting a fixed time, as long as this time is reached, the dust box is considered to be full and needs to be cleaned. However, due to the uncertainty of the degree of dirtiness of the environment, the amount of garbage collected in the same length of time will be greatly different, and the false detection rate caused by this method is too high. Therefore, solving the need to accurately detect whether the dust box is full of dust can bring users a good user experience.

The present application proposes a detection method for the dust box's dust fullness.

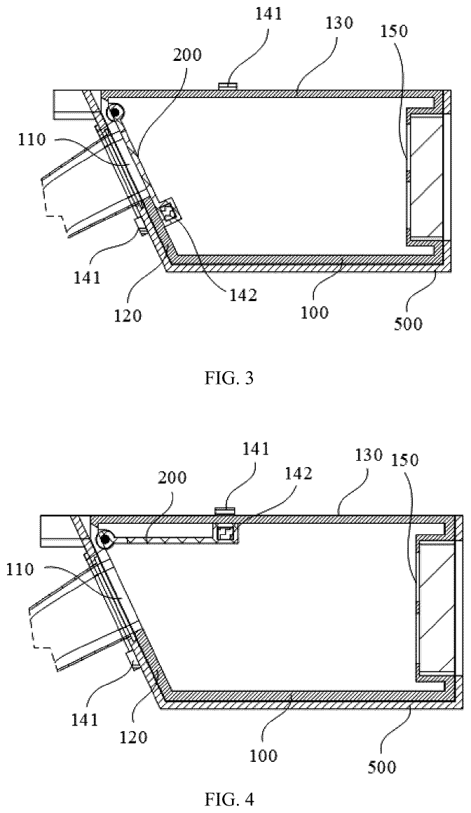

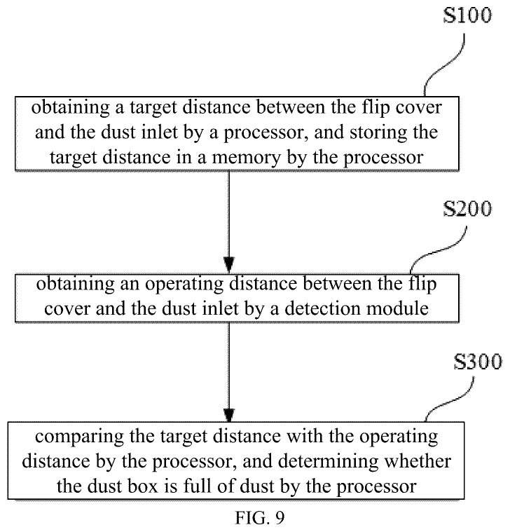

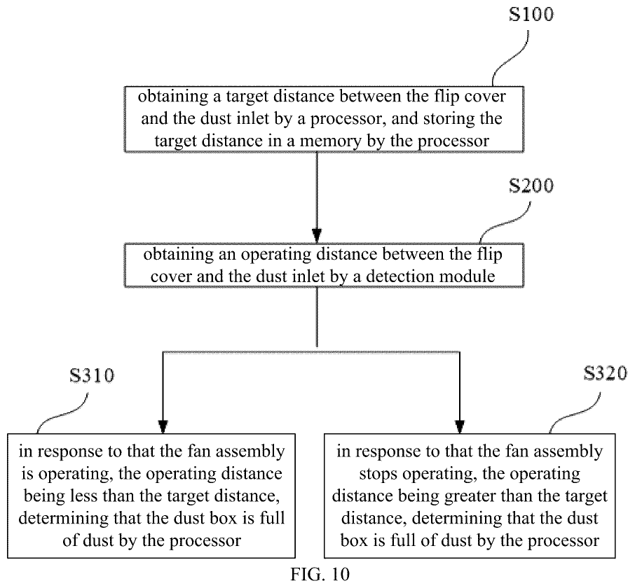

Please refer to FIG. 3, FIG. 9 and FIG. 10, in an embodiment of the present application, the dust box is applied to a cleaning device, the cleaning device includes a fan assembly and a dust box, the fan assembly communicates with the dust box via a dust inlet 110, and a flip cover 200 flipped to open and close the dust inlet 110 is provided in the dust box. The detection method for the dust box's dust fullness includes:

Step S100, obtaining a target distance between the flip cover 200 and the dust inlet 110 by a processor 300, and storing the target distance in a memory 400 by the processor.

Step S200, obtaining an operating distance between the flip cover 200 and the dust inlet 110 by a detection module 140.

Step S300, comparing the target distance with the operating distance by the processor 300, and determining whether the dust box is full of dust by the processor 300.

It should be noted that the flip cover 200 opens and closes the dust inlet 110 by flipping in the dust box, that is, the flip cover 200 needs to occupy the space in the dust box during the process of opening the dust inlet 110 and closing the dust inlet 110. When the garbage in the dust box is collected to a certain extent, the garbage will hinder the flipping of the flip cover 200, and the amount of garbage at this time is close to overflowing from the dust inlet 110, that is, the dust box is full at this time.

In this way, the technical solution of the present application firstly tests the target distance of the distance between the flip cover 200 and the dust inlet 110 under various usage conditions in a state that the dust box is full of dust. For example, when the cleaning device is at the beginning of use or in use, whether the flip cover 200 can open the dust inlet 110 or maintain flipping to a reasonable position; or, when the cleaning device is in the state of not being used or just finishing use, whether the flip cover 200 can cover the dust inlet 110 or be covered to a reasonable position. The distance between the flip cover 200 and the dust inlet 110 under this judgment standard is the target distance. After determining the target distance, the cleaning device, in any condition, the detection module 140 will detect the actual distance between the flip cover 200 and the dust inlet 110. The actual distance is the operating distance between the flip cover 200 and the dust inlet 110. Then, by comparing the operating distance and the target distance, if the operating distance is outside the range of the target distance, it is determined that the dust box is full and needs to be cleaned; if the operating distance is within the target distance, it is determined that the dust box is not full and can continue to be used. It can be understood that the standard for whether the dust box is full of dust is that the dust inlet 110 can be used normally, and the relationship between the flip cover 200 and the dust inlet 110 can better reflect whether the dust inlet 110 is in a normal use state, thereby achieving a relatively accurate determination of whether the dust box is full of dust.

It can be understood that in the condition that the dust box is not full, the flip cover 200 will have a standard state, for example, the flip cover 200 covers the dust inlet 110 when stop operating, and the flip cover 200 opens the dust inlet 110 during the operating process. Once the dust box is full of dust, the standard state of the flip cover 200 will be changed. In this way, the target distance is defined as the distance between the flip cover 200 and the dust inlet 110 when the flip cover 200 is in a condition other than the standard state, and is stored in the memory 400. Thus, the cleaning device in any use stage can easily and accurately determine whether the dust box is currently full of dust and whether the dust box needs to be cleaned by calling the target distance and comparing the target distance with the operating distance of the flip cover 200. In this solution, the dust-full state is not only the state where the dust box is full of garbage, but also the condition where the flip cover 200 is out of the standard state due to other factors. At this time, the dust box cannot be used normally. By the way of prompting that the dust is full, the user can be reminded to clean and maintain it. It should be noted that the target distance can be directly measured by the distance from the flip cover 200 to the dust inlet 110 at a predetermined circumferential position, or by measuring the flip angle of the flip cover 200 to reflect the distance from the flip cover 200 to the dust inlet 110 at a predetermined circumferential position.

Furthermore, in this embodiment, referring to FIG. 10, step S300 includes:

Step S310, in response to that the fan assembly is operating, the operating distance being less than the target distance, determining that the dust box is full of dust by the processor 300.

Before the fan assembly is operating, if the dust box is not full, the flip cover 200 will remain cover the dust inlet 110. If the cleaning device is used, under the action of the fan assembly, the flip cover 200 will be blown up to open the dust inlet 110. Since the wind force of the fan assembly is relatively large, it can ensure that the garbage is sucked into the dust box, thus, during use, the flip cover 200 needs to open the dust inlet 110 as much as possible. In this condition, the target distance is from zero to a preset value. When the distance between the flip cover 200 and the dust inlet 110 is within the preset value, the dust box cannot be used normally. When the distance between the flip cover 200 and the dust inlet 110 is outside the preset value, the dust box can be used normally. In this way, by comparing the operating distance and the target distance, if it comes out that the operating distance is less than the target distance, determining that the dust box is full of dust, and notifying the user to clean the dust box or stop the operation of the cleaning device; if it comes out that the operating distance is greater than or equal to the target distance, determining that the dust box is not full of dust, and the cleaning device can keep operating.

Specifically, in this embodiment, within a range of the target distance, an angle between the flip cover 200 and a side wall of the dust box where the dust inlet 110 is provided is between 0° and 30°. It can be understood that the size of the above angle reflects that the flip cover 200 has a limited opening range for the dust inlet 110, and the dust box is greatly blocked by the garbage. At this time, the amount of garbage in the dust box is relatively large, which has reached the condition that the normal operation of the cleaning device is affected. The target distance converted within the angle range is compared with the operating distance to determine whether the dust box is full of dust. Certainly, in other embodiments, the user can also set the angle between the flip cover 200 and the side wall of the dust box where the dust inlet is provided to be between 0° and 45° or between 0° and 15° according to their own usage habits, types of garbage or environmental factors, and the distance between the flip cover 200 and the dust inlet 110 is the target distance.

In an embodiment, referring to FIG. 10, step S300 further includes:

Step S320, in response to that the fan assembly stops operating, the operating distance being greater than the target distance, determining that the dust box is full of dust by the processor 300.

In the process of the fan assembly switching from the operating state to the stop operating state, when the dust box is not full, the flip cover 200 can automatically flip to the position of covering the dust inlet 110. At this time, the operating distance of the flip cover 200 is preferably zero. Considering that part of the large garbage may be stuck in the dust inlet 110, the operating distance of the flip cover 200 can also be appropriately greater than zero, which is manifested as the flip cover 200 not tightly covering the dust inlet 110, and can also be defined as the condition that the dust box is not full. Thus, if the detection module 140 detects that the operating distance of the flip cover 200 is greater than the target distance at this time, the flip cover 200 is disturbed by environmental factors such as garbage, so that it cannot effectively cover the dust inlet 110 or is in a position to effectively prevent garbage from falling out, it can be determined that the dust box is full or cannot be used normally, and the user is notified to clean the dust box. If the detection module 140 detects that the operating distance of the flip cover 200 is less than or equal to the target distance at this time, the flip cover 200 can effectively cover the dust inlet 110, thereby preventing garbage from falling out of the dust box, it can be determined that the dust box is not full, and the cleaning device can be used normally.

Specifically, in this embodiment, a value of the target distance is zero. In this condition, the fan assembly is not operating, and the only criterion for the dust box to be not full is that the flip cover can tightly cover the dust inlet 110. If the detection module 140 determines that the operating distance of the flip cover 200 is greater than zero, thus notifying the user to clean the dust box, in this way, it can prevent garbage from falling out of the dust box to the greatest extent and ensure the user's experience. Certainly, in other embodiments, the target distance is provided to zero to a preset value, and the size of the preset value depends on the user's usage habits, the type of garbage, or environmental factors.

The present application proposes a dust box assembly.

Please refer to FIG. 1 to FIG. 4 and FIG. 11, in an embodiment of the present application, the dust box is applied to a cleaning device, the cleaning device further includes a processor 300 and a memory 400, and the memory 400 stores a control program executable on the processor 300. In response to that the processor 300 executes the control program, the steps of the detection method described above is implemented. The dust box assembly includes:
a box body 100 provided with a dust inlet 110;
a flip cover 200 flipably provided in the box body 100 to open and close the dust inlet 110; and
a detection module 140 electrically connected to the processor 300, and the detection module 140 is configured to obtain an operating distance between the flip cover 200 and the dust inlet 110.

Without loss of generality, the box body 100 is further provided with an air outlet 150. When the fan assembly is operating, the garbage enters the box body 100 from the dust inlet 110 along with the airflow, and then the airflow leaves the box body 100 from the air outlet 150, thereby ensuring the fluidity of the air, and realizing garbage collection. It should be noted that in the process of collecting garbage, the flip cover 200 can rotate to open the dust inlet 110 under the action of holding and pushing of the airflow, and when the fan assembly stops operating, the flip cover 200 can automatically rotate to cover the dust inlet 110. In this way, the detection module 140 detects the operating distance of the flip cover 200, when it is detected that the operating distance of the flip cover 200 deviates from the target distance mentioned above, it can be concluded that the flip cover 200 cannot effectively control the dust inlet 110, and the garbage in the box body 100 is easy to fall out of the box body 100 via the dust inlet 110, which is equivalent to determining that the dust box is full of dust at this time, and the dust box needs to be cleaned or inspected and maintained. The detection of the detection module 140 to the flip cover 200 can perform under the condition that the fan assembly is operating or not operating, which contains all operating states of the cleaning device, and the effective control of the flip cover 200 over the dust inlet 110 directly reflects the function of the dust box. By detecting the relationship between the flip cover 200 and the dust inlet 110, it can better reflect whether the dust inlet 110 is in a normal use state, thereby achieving a relatively accurate judgment on whether the dust box is full of dust.

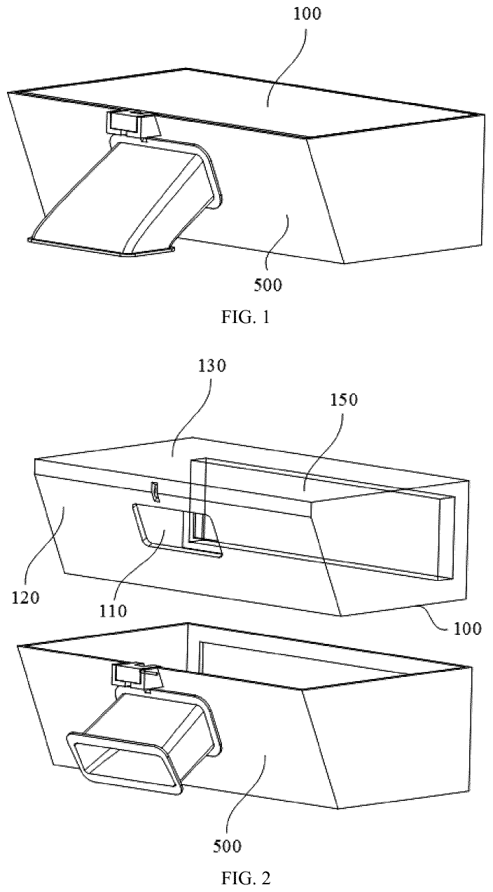

It should be noted that the automatic rotation of the flip cover 200 to cover the dust inlet 110 can be achieved by gravity, or by providing magnetic members between the side wall of the dust inlet 110 and the flip cover 200 that magnetically attracts each other, so as to achieve automatic closing of the dust inlet 110 by the flip cover 200, and also ensure that the flip cover 200 can be held and pushed against the flip cover 200 to rotate to open the dust inlet 110 when the fan assembly is operating. In addition, the cleaning device is provided with an installation shell 500, and the dust box is detachably adapted to be installed in the installation shell 500. The detection module 140 can be provided on the box body 100 and electrically connected to the processor 300 in the cleaning device by an electrical connection structure to ensure the detachable connection between the dust box and the installation shell 500. Alternatively, the detection module 140 can also be provided in the installation shell 500, or partially provided in the installation shell 500 and partially provided in the installation shell 500, so as to facilitate the detachable connection between the dust box and the installation shell 500, so as to facilitate the cleaning of garbage in the box body 100. The installation shell 500 is provided with an adsorption flow channel (not shown in the figure) communicated with the dust inlet 110, and the adsorption flow channel is used to guide the garbage and other debris adsorbed by the cleaning device into the dust box. A suction port (not shown in the figure) is provided below the adsorption flow channel, as shown in FIG. 1 and FIG. 2. The shape of the suction port is determined according to the needs of the user, the specifications of the cleaning device, the distribution method of the components in the cleaning device, etc., which is not required in this solution, and only serves as a schematic.

In an embodiment, referring to FIG. 3 to FIG. 6, the box body 100 is provided with an air inlet side wall 120 inclined relative to a horizontal plane, the air inlet side wall 120 is provided with the dust inlet 110, and a rotating shaft of the flip cover 200 is provided at the air inlet side wall 120 and provided at an upper side of the dust inlet 110. In response to that the cleaning device stops operating, the flip cover 200 is covered at the dust inlet 110. The flip cover 200 is located on the side surface of the air inlet side wall 120 that is inclined upward. When the fan assembly is not operating, the flip cover 200 automatically flips over to cover the dust inlet 110. When the fan assembly is operating, the airflow presses against the flip cover 200, and the flip cover 200 rotates around its rotating shaft, with its lower edge away from the dust inlet 110, and the airflow carries garbage into the box body 100 from the dust inlet 110. When the fan assembly stops operating, the flip cover 200 rotates in the opposite direction under the action of gravity until it covers the dust inlet 110, so as to prevent garbage from falling out of the box body 100 from the dust inlet 110. It is understood that the flip cover 200 cannot be flipped to a vertical state at most, so as to ensure that the flip cover 200 can be flipped back to its original position when the fan assembly stops operating. Certainly, the above description is based on the condition of the normal use of the dust box. Once the box body 100 is full of garbage, it will affect the opening and closing of the dust inlet 110 by the flip cover 200. For example, when the fan assembly is operating, the airflow cannot effectively push against and open the flip cover 200; when the fan stops operating, the flip cover 200 cannot effectively cover the dust inlet 110, etc.

Furthermore, in this embodiment, referring to FIG. 3 and FIG. 4, the box body 100 further includes a top cover 130 connected to an upper edge of the air inlet side wall 120, the detection module 140 is provided adjacent to the dust inlet 110 or provided at the top cover 130, or the detection module 140 is provided near the dust inlet 110 and on the top cover 130, and a detection head of the detection module 140 is opposite to the flip cover 200 in a rotation direction of the flip cover 200. It can be understood that the detection direction of the detection module 140 is parallel to the rotation direction of the flip cover 200, so that the detection module 140 can directly detect the operating distance of the flip cover 200, and ensure the reliability of obtaining the operating distance of the flip cover 200. When the detection module 140 is provided adjacent to the air inlet side wall 120, the distance between the flip cover 200 and the air inlet side wall 120 detected by the detection module 140 is the operating distance. When the detection module 140 is provided adjacent to the top cover 130, with the intersection of the top cover 130 and the air inlet side wall 120 as the center, in the circumferential direction where the detection module 140 is located, the difference between the distance between the top cover 130 and the air inlet side wall 120 minus the distance between the flip cover 200 and the air inlet side wall 120 detected by the detection module 140 is the operating distance. Without loss of generality, the detection module 140 is outside the box body 100, at this time, it can be provided on the installation shell 500 or provided at the outer surface of the combination 100 to avoid occupying the space in the box body 100 and avoid being polluted or disturbed by garbage. In addition, the detection module 140 is provided adjacent to the dust inlet 110, and can be provided adjacent to the lower edge of the dust inlet 110, upper edge of the dust inlet 110 or side edge of the dust inlet 110. When the garbage in the box body 100 blocks the detection module 140 and interferes with the detection module 140 to obtain the operating distance, it also means that the garbage in the box body 100 is close to overflowing the dust inlet 110, at this time, the user can be notified to clean the dust box.

Specifically, in this embodiment, please continue to refer to FIG. 3 and FIG. 4, the detection module 140 includes a Hall sensor 141 and a first magnetic member 142 provided at the flip cover 200. It should be noted that the Hall sensor 141 is less blocked and interfered by garbage, and has a low cost. Using the Hall sensor 141 to detect the distance between the flip cover 200 and the air inlet side wall 120, thus ensuring the stability and reliability of obtaining the operating distance of the flip cover 200, and reducing the cost of the cleaning device. Specifically, two Hall sensors 141 can be provided, which are respectively provided adjacent to the air inlet side wall 120 and the top cover 130 to improve the accuracy of detecting the operating distance of the flip cover 200. More specifically, the Hall sensor 141 can be configured as a linear Hall sensor 141, which can detect the opening degree of the flip cover 200 by detecting the magnitude of the magnetic strength. Certainly, in other embodiments, the detection module 140 may also be configured as an infrared photoelectric sensor 143 or other photoelectric sensor to detect the operating distance between the flip cover 200 and the air inlet side wall 120 in the rotation direction of the flip cover 200 and in the circumferential direction where the detection module 140 is located.

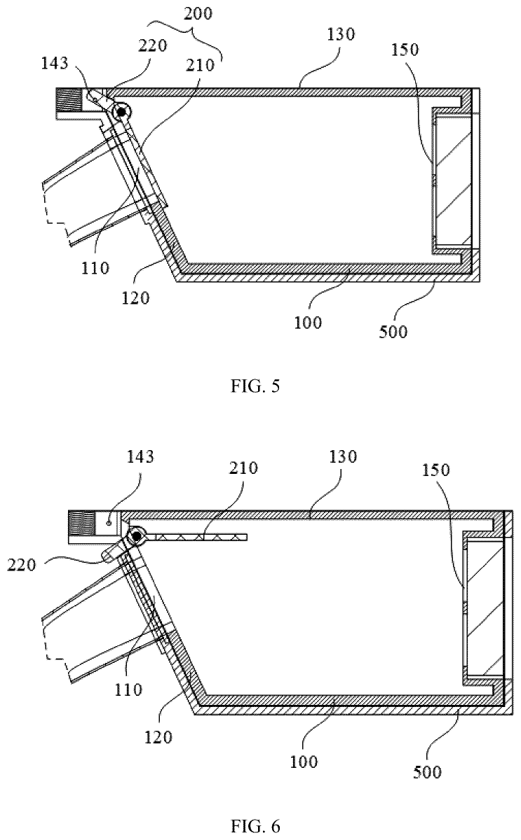

In an embodiment, referring to FIG. 5 and FIG. 6, the flip cover 200 includes a cover plate 210 and a to-be-detected part 220 provided at both sides of the rotating shaft, the cover plate 210 is provided in the box body 100 to open and close the dust inlet 110; the detection head of the detection module 140 is provided toward an extension direction of the rotating shaft and is opposite to the to-be-detected part 220 in response to that the cover plate 210 covers the dust inlet 110. It can be understood that the detection direction of the detection module 140 intersects with the rotation direction of the to-be-detected part 220, that is, the detection direction of the detection module 140 intersects or is even perpendicular to the rotation direction of the flip cover 200. In this way, when the fan assembly is operating, if the flip cover 200 rotates normally to open the dust inlet 110, at this time, the detection module 140 cannot detect the to-be-detected part 220, which means that the garbage in the box body does not interfere with the rotation of the flip cover 200, the dust box is not full, and the cleaning device can be used normally; if the flip cover 200 cannot be normally rotated to reasonably open the dust inlet 110, at this time, the detection module 140 can detect the to-be-detected part 220, which means that the garbage in the box body 100 has interfered with the rotation of the flip cover 200, the dust box is full, and the user needs to be notified to clean the dust box. When the fan assembly stops running, if the flip cover 200 is normally reset to cover the dust inlet 110, at this time, the detection module 140 can detect the to-be-detected part 220, which means that the garbage in the box body 100 has not interfered with the rotation of the flip cover 200, the dust box is not full, and the cleaning device can be used normally; if the flip cover 200 cannot be rotated normally to reasonably cover the dust inlet 110, at this time, the detection module 140 cannot detect the to-be-detected part 220, which means that the garbage in the box has interfered with the rotation of the flip cover 200, the dust box is full, and the user needs to be notified to clean the dust box. It should be noted that the to-be-detected part 220 has a certain thickness in its rotation direction, and the detection module 140 can determine the rotation range of the flip cover 200 by the blocking range of the to-be-detected part 220 on the detection module 140.

Specifically, please continue to refer to FIG. 5 and FIG. 6, the detection module 140 includes a photoelectric sensor 143. The detection direction of the photoelectric sensor 143 is perpendicular to the rotation direction of the to-be-detected part 220. In this way, when the flip cover 200 covers the dust inlet 110, the photoelectric sensor 143 can detect the to-be-detected part 220. When the flip cover 200 opens the dust inlet 110, the photoelectric sensor 143 cannot detect the to-be-detected part 220. By utilizing the detection difference of the flip cover 200 at different positions by the photoelectric sensor 143, and combining the standard state of the flip cover 200, it is possible to determine the abnormal condition of the rotation of the flip cover 200, and then concluding that the flip cover 200 cannot effectively control the garbage from falling out of the box body 100, thereby ensuring the detection accuracy and reliability of the dust box being full. Specifically, in this embodiment, the photoelectric sensor 143 is provided at the installation shell 500, and the detection direction of the detection head thereof is parallel to the extension direction of the rotating shaft. Certainly, in other embodiments, the detection module 140 may also be configured as a Hall sensor 141 to detect abnormal condition of the rotation of the flip cover 200 in the direction perpendicular to the rotation direction of the flip cover 200, thereby obtaining the operating distance of the flip cover 200.

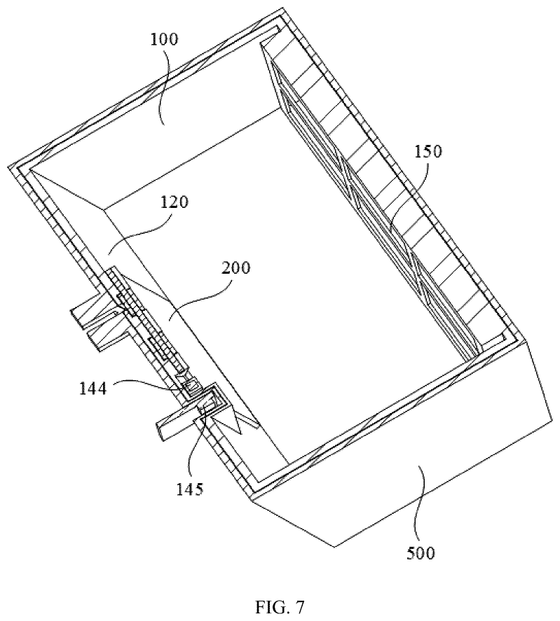

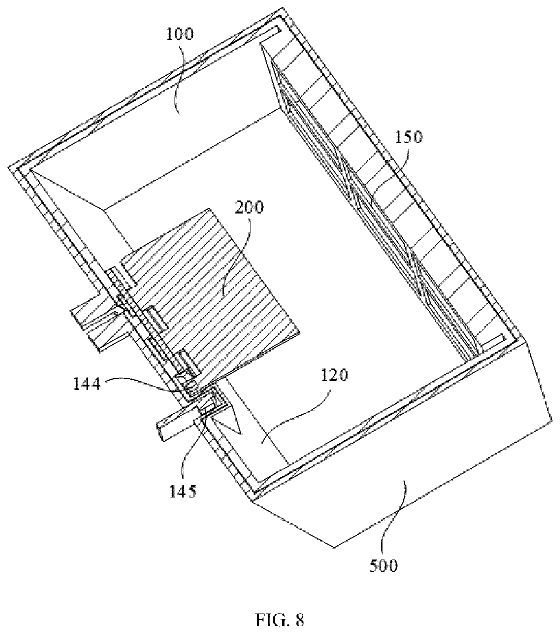

In an embodiment, referring to FIG. 1, FIG. 2, FIG. 7 and FIG. 8, the detection module 140 includes a magnetic angle sensor 145 and a second magnetic member 144 provided at the flip cover 200. Without loss of generality, the second magnetic member 144 is provided at a vertical plane of the rotating shaft of the flip cover 200. Taking the rotating shaft of the flip cover 200 as the center, using the magnetic angle sensor 145 to detect the rotation angle of the second magnetic member 144 along with the rotating shaft, so as to determine the rotation angle of the flip cover 200. In combination with the standard state of the flip cover 200, the abnormal rotation condition of the flip cover 200 can be determined, and the distance between the flip cover 200 and the dust inlet 110 at a predetermined circumferential position of the flip cover 200 can be converted according to the rotation angle of the flip cover 200, thereby concluding that the flip cover 200 cannot effectively control the garbage from falling out of the box body 100, thereby ensuring the detection accuracy and detection reliability of the dust box's dust fullness. Specifically, in this embodiment, the magnetic angle sensor 145 is provided at the installation shell 500. Certainly, in other embodiments, at least two of the above-mentioned detection method of detecting the distance between the flip cover 200 and the dust inlet 110 in parallel with the rotation direction of the flip cover 200, the above-mentioned detection method that perpendicular to the rotation direction of the flip cover 200, and the above-mentioned method of detecting the rotation angle of the flip cover 200 can be integrated into one, thereby ensuring the reliability and accuracy of obtaining the operating distance of the flip cover 200, and improving the detection accuracy of the dust box's dust fullness.

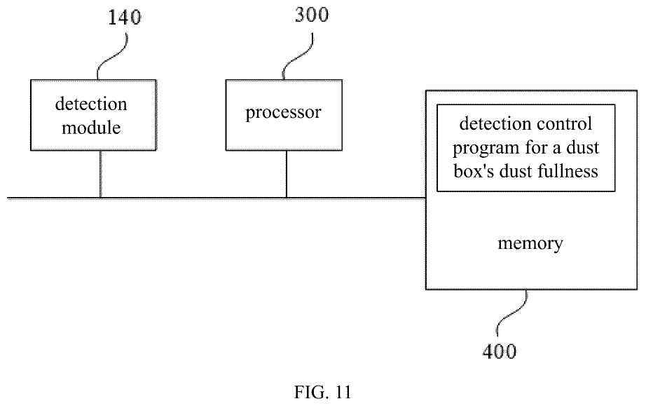

The present application further proposes a cleaning device, the cleaning device includes a dust box assembly, AND the specific structure of the dust box assembly refers to the above-mentioned embodiment. Since the cleaning device adopts all the technical solutions of all the above-mentioned embodiments, it at least has all the beneficial effects brought by the technical solutions of the above-mentioned embodiments, which will not be repeated here. The cleaning device further includes a processor 300 and a memory 400. Referring to FIG. 11, the memory 400 stores a detection control program about dust box's dust fullness that can be operated on the processor 300. When the processor 300 executes the detection control program for a dust box's dust fullness, the steps of the detection method described above are implemented to ensure the detection accuracy of the dust box's dust fullness. It should be noted that the cleaning device is configured as a floor cleaning robot, a sweeping robot or a carpet cleaning robot. When the cleaning device is configured as a carpet cleaning robot, the cleaning device has the ability to flush and clean the carpet.

The present application further proposes a computer readable storage medium. Referring to FIG. 11, a control program is stored on the computer readable storage medium. The control program is a detection control program for a dust box's dust fullness. In response to that the control program is executed by a processor 300, the detection method described above are implemented. As a computer readable storage medium, any combination of one or more computer readable media can be used. The computer readable storage medium can be a computer readable signal medium or a computer readable storage medium. The computer readable storage medium can be, for example, but not limited to, an electrical, magnetic, optical, electromagnetic, infrared, or semiconductor system, device or component, or any combination of the above. More specific examples (a non-exhaustive list) of computer readable storage media include: an electrical connection with one or more conductors, a portable computer disk, a hard disk, a random access memory 400 (RAM), a read-only memory 400 (ROM), an erasable programmable read-only memory 400 (EPROM or flash memory), an optical fiber, a portable compact disk read-only memory 400 (CDROM), an optical memory 400, a magnetic memory 400, or any suitable combination of the above. In the present application, a computer readable storage medium can be any tangible medium that contains or stores a program that can be used by or in conjunction with an instruction execution system, device or component.

The above description is only an exemplary implementation of the present application and does not limit the scope of the present application. Under the inventive concept of the present application, any equivalent structure transformation made by using the description and accompanying drawings of the present application, or directly or indirectly applied in other related technical fields, is included within the scope of the present application.

What is claimed is:

1. A detection method for a dust box's dust fullness, applied to a cleaning device, wherein the cleaning device comprises a fan assembly and a dust box, the fan assembly communicates with the dust box via a dust inlet, and a flip cover flipped to open and close the dust inlet is provided in the dust box; the detection method comprises:
obtaining a target distance between the flip cover and the dust inlet by a processor, and storing the target distance in a memory by the processor;
obtaining an operating distance between the flip cover and the dust inlet by a detection module; and
comparing the target distance with the operating distance by the processor, and determining whether the dust box is full of dust by the processor.

2. The detection method for the dust box's dust fullness according to claim 1, wherein the comparing the target distance with the operating distance by the processor, and determining whether the dust box is full of dust by the processor comprises:
in response to that the fan assembly is operating, the operating distance being less than the target distance, determining that the dust box is full of dust by the processor.

3. The detection method for the dust box's dust fullness according to claim 2, wherein within a range of the target distance, an angle between the flip cover and a side wall of the dust box where the dust inlet is provided is between 0° and 30°.

4. The detection method for the dust box's dust fullness according to claim 1, wherein the comparing the target distance with the operating distance by the processor, and determining whether the dust box is full of dust by the processor comprises:
in response to that the fan assembly stops operating, the operating distance being greater than the target distance, determining that the dust box is full of dust by the processor.

5. The detection method for the dust box's dust fullness according to claim 4, wherein a value of the target distance is zero.

6. A dust box assembly, applied to a cleaning device, wherein the cleaning device further comprises a processor and a memory, and the memory stores a control program executable on the processor; in response to that the processor executes the control program, the detection method for the dust box's dust fullness according to claim 1 is implemented; the dust box assembly comprises:
a box body provided with a dust inlet;
a flip cover flipably provided in the box body to open and close the dust inlet; and
a detection module electrically connected to the processor, wherein the detection module is configured to obtain an operating distance between the flip cover and the dust inlet.

7. The dust box assembly according to claim 6, wherein the box body is provided with an air inlet side wall inclined relative to a horizontal plane, the air inlet side wall is provided with the dust inlet, and a rotating shaft of the flip cover is provided at the air inlet side wall and provided at an upper side of the dust inlet; in response to that the cleaning device stops operating, the flip cover is covered at the dust inlet.

8. The dust box assembly according to claim 7, wherein the box body further comprises a top cover connected to an upper edge of the air inlet side wall, the detection module is provided adjacent to the dust inlet and/or provided at the top cover, and a detection head of the detection module is opposite to the flip cover in a rotation direction of the flip cover.

9. The dust box assembly according to claim 7, wherein the flip cover comprises a cover plate and a to-be-detected part provided at both sides of the rotating shaft, the cover plate is provided in the box body to open and close the dust inlet; the detection head of the detection module is provided toward an extension direction of the rotating shaft and is opposite to the to-be-detected part in response to that the cover plate covers the dust inlet.

10. The dust box assembly according to claim 6, wherein the detection module comprises a Hall sensor and a first magnetic member provided at the flip cover.

11. The dust box assembly according to claim 6, wherein the detection module comprises a magnetic angle sensor and a second magnetic member provided at the flip cover.

12. The dust box assembly according to claim 6, wherein the detection module comprises a photoelectric sensor.

13. A cleaning device, comprising:
a dust box assembly;
a processor, and
a memory;
wherein the memory stores a control program executable on the processor, and when the processor executes the control program, the detection method for the dust box's dust fullness according to claim 1 is implemented.

14. A non-transitory computer readable storage medium, wherein a control program is stored on the computer readable storage medium, and when the control program is executed by a processor, the detection method for the dust box's dust fullness according to claim 1 is implemented.
